(19) United States
(12) Patent Application Publication
(10) Pub. No.: US 2008/0068195 A1
(43) Pub. Date: Mar. 20, 2008

(54) Method, System And Device For The Haptically Controlled Transfer Of Selectable Data Elements To A Terminal

(76) Inventors: Rudolf Ritter, Zollikofen (CH); Eric Lauper, Bern (CH)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/628,219

(22) PCT Filed: Jun. 1, 2005
(86) PCT No.: PCT/EP05/52506

§ 371 Date: Nov. 30, 2007

(30) Foreign Application Priority Data
Jun. 1, 2004 (EP) 04102441.5
Jun. 17, 2004 (EP) 04102783.0

(51) Int. Cl. G06F 19/00

(52) U.S. Cl. 340/669; 340/573.1

(57) ABSTRACT

A method, a system, and a device for body-controlled transmission of data elements to be selected to a terminal. Reference values and data elements associated therewith are stored in a lookup table. By at least one acceleration sensor, attachable to a part of the body of a user, acceleration values and/or vibration values able to be influenced though bodily movements of the user are captured. By a comparison module, acceleration values and/or vibration values are compared with reference values, and at least one data element selected, assigned to a reference value. By a transmission module, the at least one selected data element is transmitted to a terminal.

### TECHNICAL FIELD

The invention relates to a method, a system and a device for body-controlled transmission to a terminal of selectable data elements.

### BACKGROUND ART

In the state of the art, terminals of electronic devices in everyday use, such as, for example, portable computers, electronic notebooks (pocket PCs, handhelds, palmtops) or mobile telephones are becoming miniaturized more and more. It is thereby increasingly more difficult for the users of such terminals to operate these terminals. The difficulty lies in particular in the input of data elements into such terminals. Entering data elements using a stylus is known. For this purpose, a keyboard is displayed on the terminal, for example, and the user selects data elements using the stylus. In such an input method, the user must concentrate completely on the input of data elements, and can hardly continue a conversation at the same time, for instance. Such an input of data often takes much longer than a comparable note made in a notebook. Using a special writing region on the terminal, the entry of data elements into the terminal by means of the writing of symbols in this writing region is also known in the state of the art. With such an input of data elements, the user can use the accustomed notation or an easily learned notation of symbols for input of data elements. Since character recognition is thereby carried out by the terminal, the user must constantly check whether symbols he has entered have also been correctly recognized by the terminal. The user must once again concentrate much too much on the input of data elements, and during this time is not able to absorb important information from his surroundings. It is also possible to enter data elements via a keyboard of the terminal. So that the keyboard is not too big, and is able to be installed at all on the miniaturized terminal, the keys of the keyboard are multiply used. Thus, by pressing a key once, the letter “a” is entered, by pressing this key a second time, the letter “b”, by pressing this key a third time, the letter “c,” or by pressing this key a fourth time, the digit “1.” It is apparent that only the input of very brief commands or notes is made possible with such a multiple use of keys. The input methods of the state of the art for input of data elements into a terminal are often very involved. The input of data elements into the terminal often requires two hands. Only people with practice manage to operate the terminal in a one-handed manner without looking, but only for relatively simple commands such as the dialing of a speed number on the mobile radio telephone or switching off an alarm on a notebook device. In the state of the art, the input of data elements into a terminal always takes place via a device such as a keyboard or a mouse, for example. Therefore no hands-free operation of terminals, i.e. operation without using an input device, is possible in the state of the art.

### DISCLOSURE OF INVENTION

It is an object of the present invention to propose a new method, a new system and a new device for body-controlled transmission of selectable data elements to a terminal which do not have the drawbacks of the state of the art.

These objects are achieved according to the present invention in particular through the elements of the independent claims. Further advantageous embodiments follow moreover from the dependent claims and the description.

These objects are achieved according to the invention in that reference values as well as assigned data elements are stored in a look-up table, acceleration values and/or vibration values able to be influenced by bodily movements of the user are captured by means of at least one acceleration sensor, attachable to a part of the body of a user, acceleration values and/or vibration values are compared with reference values by means of a comparison module, and at least one data element assigned to a reference value is selected, and the at least one selected data element is transmitted to the terminal by means of a transmission module. The at least one acceleration sensor can be attached to any place and in any way to a part of the body of the user. Thus an acceleration sensor may be installed in a wristwatch, in a finger ring, in an article of clothing or in a glove, for instance. It is also conceivable, for example, to affix acceleration sensors to suitable parts of the body such as, for example, fingers of a user. Such a method has the advantage that a user is able to transmit data elements to a terminal in a simple, convenient and intuitive way. Through such a transmission of data elements to a terminal an especially simple control of a terminal is made possible for a user. It is possible in particular to carry out such a transmission in such a way that it is not noticeable to third parties. For example, a click function can be triggered by means of a short beating together or bringing together of thumb and index finger, this click function triggering, for example, the moving on to the next overhead transparency or slide during a presentation using a projector.

In an embodiment variant, picture references are stored in the look-up table, at least one reference value and a corresponding data element being assigned to a picture reference, picture data being shown to the user by means of a display unit, and a picture data cutout from the picture data shown corresponding to the direction of view of the user being determined by means of a direction-of-view module, and the picture data cutout being compared with picture references by means of the comparison module, and a data element being selected on the basis of this comparison. With such an embodiment variant, in particular the control of a computer is able to be carried out in an intuitive and simple way. Thus the picture data could relate to the desktop of a computer display, for example. The user can then control the mouse indicator according to the direction of view, for instance, and trigger the mouse click by tapping on the edge of the keyboard using the thumb, for example.

In an embodiment variant, sequences of reference values as well as assigned data elements are stored in the look-up table, captured acceleration values and/or vibration values are processed by means of a sequence module into sequences of acceleration values and/or vibration values, and, by means of the comparison module, sequences of acceleration values and/or vibration values are compared with sequences of reference values of the look-up table, and at least one data element assigned to a sequence of reference values is selected. Such an embodiment variant has the advantage that even more complicated bodily movements such as, for instance, the rotation of the hand and the subsequent quick closing of the hand may be assigned to a data element.

In a further embodiment variant, the transmission of a data element to the terminal is signaled to the user by means of a signalling device. Such an embodiment has the advantage in particular that the user is informed as soon as a data element has been transmitted to the terminal. This can take place by means of a vibrator built into a wristwatch or through the display of a corresponding icon by means of the display unit, for example.

In another embodiment variant, the accomplishment of points of a bodily movement is signaled to the user by means of a feedback device. For example, the feedback device comprises mechanical means such as e.g. a vibrator installed on the wristwatch which emits a short vibration similar to a mouse click as soon as the user has completed a definable bodily movement such as a 90° rotation of the hand, for instance. Such a method has in particular the advantage that the user remains informed about the execution of bodily movements.

In a further embodiment variant, position references and assigned data elements are stored in the look-up table, body-position data for the user are captured by means of a position module, and position references and body-position data are compared and a corresponding data element is selected by means of the comparison module. Such a method has the advantage in particular that when sitting, for instance, a different data element is selectable than when standing or walking. Thus a 90° rotation of the hand when sitting can relate to a diverting to a fixed net telephone of a call to a mobile radio telephone, for example, whereas the same bodily movement when standing or walking relates to the receiving of a call using the mobile radio telephone.

In another embodiment variant, picture data are shown to the user by means of a retinal-scanning display and/or the direction of view of the user is determined by means of an eye-tracking system. Such an embodiment variant has the advantage in particular that a hands-free operation of a terminal is made possible in that it is determined by means of the eye-tracking system and the retinal-scanning display, which data element the user is looking at, and this data element is selected, for example, by means of a bringing together or a beating together of thumb and index finger, and is transmitted to a terminal. Such an embodiment variant also has the advantage that commercially available components can be used for carrying out the method according to the invention.

In a further embodiment variant, the display of picture data and the capture of the direction of view of the user is carried out by means of an interactive MEMSRSD. Such an embodiment variant has in particular the advantage that extremely miniaturized components can be used which are able to be easily installed in a pair of eyeglasses of the user, for example.

In another embodiment variant, the acceleration sensor is brought into an energy-saving idle mode based on definable deactivation criteria, and the acceleration sensor is activated out of the energy-saving idle mode, through selection of the direction of view of the user, on a definable activation picture element of the displayed picture data. Such an embodiment variant has the advantage in particular that optimal energy consumption may be achieved. The deactivation criteria could consist in the user not having carried out the method according to the invention for a definable interval of time, for example, and thereafter the energy-saving idle mode becomes activated. The deactivation criteria can in particular also be designed in a user-specific way, in a user-adaptable way and/or according to a definable instruction mechanism.

In another embodiment variant, the acceleration sensor is supplied with electrical energy by means of an energy store and/or by means of a solar generator and/or by means of an automatic movement generator and/or by means of a fuel cell system. Such an embodiment variant has in particular the advantage that commercially available systems can be used for the energy supply. Such an embodiment variant also has the advantage that through the selection of the energy supply system an especially high availability, e.g. over years, an especially miniaturized design, or a particularly economical manufacture is facilitated.

In a further embodiment variant, a data element is stored with a device identifier in the look-up table. Such an embodiment variant has the advantage that the tapping on a hard surface using the index finger brings about the switching on of the projector, for example, whereas the tapping using the middle finger caused a switching off of the room illumination. Furthermore different patterns are possible, such as finger click between thumb and index finger for the function “next transparency,” between thumb and middle finger for the function “one transparency back,” double click between thumb and index finger for the function “go to the first transparency”, etc. Furthermore the rubbing of fingers or the snapping of fingers can likewise be registered by the device, and corresponding data elements can be selected and transmitted to a terminal. A very complex body language can thereby be developed for transmission of data elements to a terminal.

### BRIEF DESCRIPTION OF DRAWING(S)

Embodiment variants of the present invention will be described in the following with reference to examples. The examples of the embodiments are illustrated by the following attached FIGURE(s):

FIG. 1 shows a block diagram with the individual components of the system according to the invention for body-controlled transmission of data elements to a terminal.

### MODE(S) FOR CARRYING OUT THE INVENTION

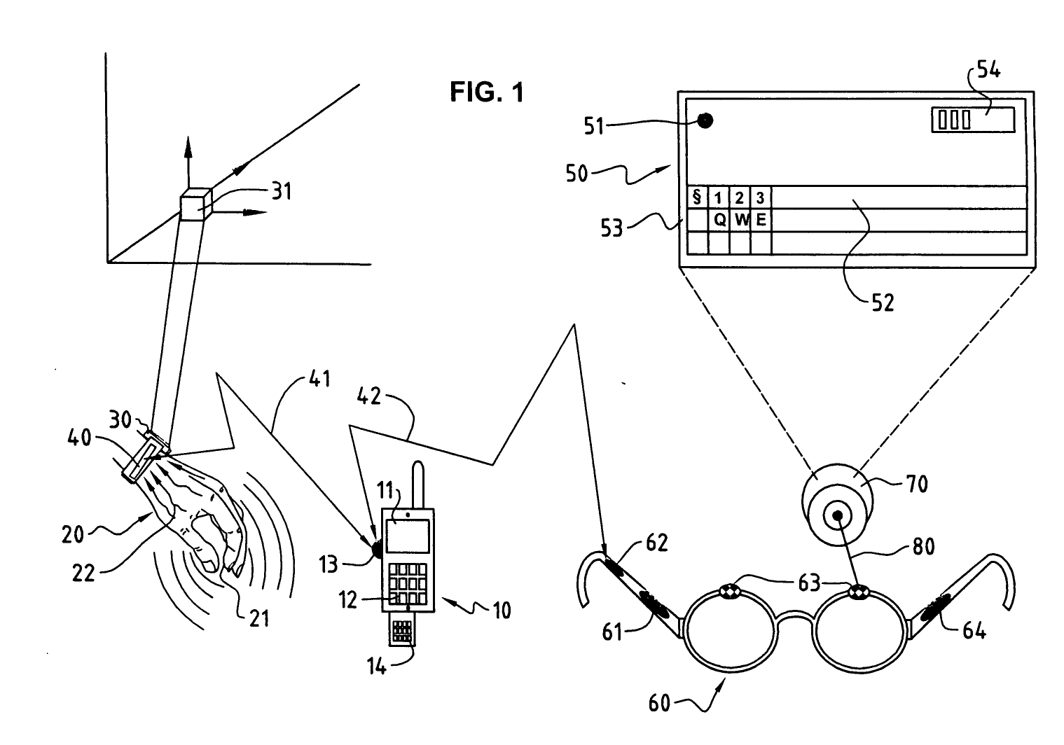

In FIG. 1, the reference numeral 31 refers to an acceleration sensor. As shown in FIG. 1, the acceleration sensor 31 can be disposed in a wristwatch 30, for example. Acceleration sensors are known in the state of the art, and are produced and marketed by the company VTI Technologies (www.vti.fi), for example. The acceleration sensor 31 is also referred to as an accelerometer in the state of the art. The acceleration sensor 31 can be produced in a highly integrated way, and thus allows itself to be easily installed as an additional device in a wristwatch 30. The acceleration sensor 31 can register both one-dimensional, two-dimensional as well as also three-dimensional acceleration values and/or vibration values. The acceleration sensors can also be designed in such a way that not only 3D, but also 6D measurements are possible. Thus 3D forces and 3D torques can be registered at the same time. Designated by the term acceleration here is a rather deterministic dimension, as occurs for example with a definable rotation of a bodily part, such as, for instance, the rotation of the wrist or the flexion of the forearm. Designated by the term vibration here is a rather random dimension, such as occurs, for example, with the vibration of parts of the hand during quick beating together of index finger and thumb or with fast tapping with a finger on a hard surface. In the state of the art, motion sensors are known which are able to register some thousandths of a g (g signifies the gravitational acceleration on the Earth, and amounts to approximately 9.81 m/s²) to some thousand g. In the registration of smaller acceleration values, in particular the position of an object can be precisely registered and followed over longer periods of time. In recording larger acceleration values, in particular procedures which run with high dynamics can be detected. The wristwatch shown in FIG. 1 has the necessary means for accommodating an acceleration sensor 31 as well as for the further processing of the acceleration values and/or vibration values captured by the acceleration sensor 31. The wristwatch 30, and with it the acceleration sensor 31, is attached on the wrist of a hand 20 of a user, as shown in FIG. 1. The wristwatch 30 can comprise a wireless communication interface 40. As shown in FIG. 1, through suitable movement of the fingers 21, the user can trigger acceleration waves and/or vibration waves 22, which are transmitted, for example, via the bones in the hand and the tissue of the hand 20 of the user to the wristwatch 30, and are able to be captured by the acceleration sensor 31 as acceleration values and/or vibration values.

The reference numeral 10 in FIG. 1 refers to a terminal. The terminal 10 can be a palmtop computer, a laptop computer, a mobile radio telephone, a television set, a video projector, an automated teller machine, a play station, or any other terminal. Designated here as terminal is a piece of equipment that can be operated by a user via an input device such as, for example, a keyboard, control knobs or switches. In FIG. 1, the terminal 10 is shown as a mobile radio telephone. The terminal 10 can comprise a display 11, an input device 12, a wireless communication interface 13 and/or an identification card 14.

In FIG. 1, the reference numeral 60 refers to communication spectacles for the display of picture data and for capturing the direction of view of the user. The communication spectacles 60 comprise a display unit for displaying picture data to the user as well as for capturing the direction of view of the user via a direction-of-view-capture module. The display unit and the direction-of-view-capture module can be implemented as interactive MEMSRSD 63 (MEMSRSD: Micro-Electro-Mechanical Systems Retinal Scanning Display), as shown in FIG. 1. By means of the interactive MEMSRSD 63, picture data can be projected via light beams 80 directly onto the retina of an eye 70 of the user, and the coordinates of the picture focused by the user are captured, or respectively the direction of view of the user. The communication spectacles 60 can comprise a wireless communication interface 62, control electronics 61, and an energy source 64. By means of the display unit of the communication spectacles 60 or respectively the interactive MEMSRSD 63, picture data can be presented to the user in such a way that the user is given the impression of seeing the virtual picture 50 shown in FIG. 1, for example. Which picture data of the virtual picture 50 is being viewed by the user can be captured by means of the view capturing module of the communication spectacles 60 or respectively the interactive MEMSRSD 63. Thus, a keyboard 52, a configuration point 51 or a menu 54, for example, can be shown on a cutout 53 of the retina of the user, by means of the display unit of the communication spectacles 60, whereby, by means of the view capture module of the communication spectacles 60, it is possible to register which of the elements shown in the virtual picture 50 the user is looking at right now.

Data connections 41, 42 are able to be set up via the mentioned wireless communication interfaces. The wireless communication interfaces can be implemented, for instance, as Bluetooth interface, WLAN interface, as ZigBee interface or as any other wireless communication interface, in particular as NFC interface (NFC: near field communication). To minimize energy consumption, certain of the wireless communication interfaces can be designed as unidirectional communication interfaces. Via the data connections 41, 42, captured acceleration values and/or vibration values, picture data, data elements, data about the direction of view of the user, tax data or any other data can be transmitted between the described pieces of equipment and components. Not only the data connections 41, 42 shown schematically in FIG. 1 are conceivable of course, but also a data connection between the wireless communication interface of the wristwatch 30 and the wireless communication interface of the communication spectacles, for example.

The mentioned pieces of equipment and components, i.e. for example the wristwatch 30, the terminal 10 or the communication spectacles 60, can comprise means for storing data and software modules as well as means for the execution of software modules, i.e. in particular a microprocessor with a suitable data and software memory. The software modules can thereby be configured such that by means of the data connections 41, 42 as well as suitable communication protocols a distributed system is made available for carrying out the functions and sequences described in the following. Of course the software modules can be developed and made available in a relatively short time by means of modern development environments and software languages.

For the body-controlled transmission of a data element to a terminal 10, first reference values and assigned data elements are stored in a look-up table. The look-up table can be accommodated in any memory area of the mentioned pieces of equipment and components, for example in a memory area of the wristwatch 10. For the storage of the reference values and assigned data elements, for example, the wristwatch 10 has a software module and a display unit for sequential display of data elements as well as for capturing acceleration values and/or vibration values able to be registered during the display of a data element. Thus, for example, the data element “j” (for a yes decision) can be shown to the user during a training phase, the user carrying out the bodily movement desired from him for selection of the data element “j”, for example a tapping of the index finger on a hard surface such as a table. For example, characteristic features are captured by means of a suitable software module from the thus captured acceleration values and/or vibration values, for instance the average acceleration and the maximum acceleration, and are stored as reference values in the look-up table, the data element “j” being assigned to these reference values. Any desired reference values and assigned data elements can be stored in the look-up table using this method. It is of course clear to one skilled in the art that suitable methods of signal processing, for example, can be used for the processing of the acceleration values and/or vibration values, such as e.g. a maximum likelihood test, a Markov model, an artificial neural network, or any other suitable method of signal processing. It is also possible, moreover, when storing the reference values, to store at the same time picture references from the picture data shown to the user via the communication spectacles 60 and viewed according to the direction of view of the user.

The wristwatch 30 subsequently comprises a look-up table with stored reference values, data elements as well as possibly picture references. The user can then trigger the switching of pictures during a slide presentation, the acceptance of an incoming call from a mobile radio telephone, or any other function of a terminal, for example by tapping with the index finger on a hard surface. Acceleration values and/or vibration values, which arise through the tapping, are thereby captured by the acceleration sensor and transmitted to the comparison module via suitable means, such as, for instance, a data connection between the acceleration sensor and a terminal with a high-capacity microprocessor and stored comparison module implemented as software module, for instance. The comparison module then accesses reference values of the look-up table, and compares these reference values with the captured acceleration values and/or vibration values. Of course this comparison can be based on different methods of information technology and signal processing, for example on a maximum likelihood test, on a Markov model or on an artificial neural network. As soon as a reference value and the captured acceleration values and/or vibration values are categorized by the comparison module as being sufficiently in agreement, then the data element assigned to the reference value can be transmitted to the terminal, for example by means of a transmission module implemented as software module. The data element comprises, for example, a symbol according to the ASCII standard, a coded control command according to a standard for control of a terminal, or any other data element. Together with the communication spectacles, it is furthermore possible for a menu entry viewed by the user to be selected and executed from the picture data shown to the user, for example by tapping with the index finger. Of course the menu entry can relate to a function for control of the terminal 10, such as looking up an entry in an address book, for instance, or any other function for control of the terminal 10.

Through the bringing together or beating together of thumb and index finger, for example, mechanical waves are triggered in the hand and in the wrist, which waves are characteristic for this bodily movement and which mechanical waves can be captured via an acceleration sensor accommodated in a wristwatch, i.e. in the housing of the wristwatch, for instance. The transmission of the mechanical waves takes place both via the tissue as well as the bones of the hand and of the wrist, or respectively via other body parts. Through a suitable processing of the captured acceleration values and/or vibration values, characteristic features can be determined which enable data elements to be selected in a body-controlled way and transmitted to a terminal. The mechanical waves caused by bodily motions comprise in each case features that are characteristic for the respective bodily movement, so that the body-controlled selection of a data element and transmission to a terminal is made possible for a large multiplicity of data elements.

1-31. (canceled)

32: A method of body-controlled transmission to a terminal of data elements to be selected, reference values as well as assigned data elements being stored in a look-up table, wherein
by at least one acceleration sensor, attachable to a part of the body of a user, acceleration values and/or vibration values able to be influenced though bodily movements of the user are captured,
by a comparison module, acceleration values and/or vibration values are compared with reference values, and at least one data element assigned to a reference value is selected, and
by a transmission module, the at least one selected data element is transmitted to the terminal.

33: The method according to claim 32, wherein
picture references are stored in the look-up table, at least one reference value and a corresponding data element being assigned to a picture reference,
picture data are shown to the user by of a display unit, and a picture data cutout from the shown picture data corresponding to the direction of view of the user is determined by a view direction module, and
the picture data cutout is compared with picture references by the comparison module, and a data element is selected based on this comparison.

34: The method according to claim 32, wherein sequences of reference values as well as assigned data elements are stored in the look-up table, captured acceleration values and/or vibration values are processed by a sequence module into sequences of acceleration values and/or vibration values, and, by the comparison module, sequences of acceleration values and/or vibration values are compared with sequences of reference values of the look-up table, and at least one data element assigned to a sequence of reference values is selected.

35: The method according to claim 32, wherein the transmission of a data element to the terminal is signaled to the user by a signalling device.

36: The method according to claim 32, wherein accomplishment of points of a bodily movement is signaled to the user by a feedback device.

37: The method according to claim 32, wherein position references and assigned data elements are stored in the look-up table, body-position data for the users are captured by a position module, and position references and body-position data are compared and a corresponding data element is selected by the comparison module.

38: The method according to claim 33, wherein picture data are shown to the user by a retinal-scanning display and/or the direction of view of the user is determined by an eye-tracking system.

39: The method according to claim 33, wherein the display of picture data and the capture of the direction of view of the user is carried out by an interactive MEMSRSD.

40: The method according to claim 33, wherein the acceleration sensor is brought into an energy-saving idle mode based on definable deactivation criteria, and the acceleration sensor is activated out of the energy-saving idle mode, through selection of the direction of view of the user, on a definable activation picture element of the displayed picture data.

41: The method according to claim 32, wherein the acceleration sensor is supplied with electrical energy by an energy store and/or by a solar generator and/or by an automatic movement generator and/or by a fuel cell system.

42: The method according to claim 32, wherein a data element is stored with a device identifier in the look-up table.

43: A system for body-controlled transmission to a terminal of data elements to be selected, the system comprising:
a look-up table for storing reference values as well as assigned data elements;
an acceleration sensor attachable to a part of the body of a user for capturing acceleration values and/or vibration values able to be influenced by bodily movements of the user;
a comparison module for comparing acceleration values and/or vibration values with reference values, a data element assigned to a reference value being selectable by the comparison module; and
a transmission module for transmitting the selected data elements to a terminal.

44: The system according to claim 43, wherein
picture references are storable in the look-up table, at least one reference value and a corresponding data element being assignable to a picture reference,
the system comprises a display unit for display of picture data to the user and a direction-of-view-capture module for capturing the direction of view of the user as well as for determining a picture data cutout corresponding to the direction of view of the user, and
the comparison module comprises means for comparing a picture data cutout with picture references and for selecting a data element based on this comparison.

45: The system according to claim 43, wherein sequences of reference values as well as assigned data elements are storable in the look-up table, the system comprises a sequence module for capturing and processing sequences of acceleration values and/or vibration values, and the comparison module comprises means for comparing sequences of acceleration values and/or vibration values with sequences of reference values as well as for selecting a data element assigned to a sequence of reference values.

46: The system according to claim 43, wherein the system comprises a signalling device for signalling to the user the transmission of a data element to the terminal.

47: The system according to claim 43, wherein the system comprises a feedback device for signalling to the user accomplishment of points of a bodily movement.

48: The system according to claim 43, wherein position references and assigned data elements are storable in the look-up table, body-position data for the user being able to be captured by a position module, and position references and body-position data being comparable by the comparison module, and a corresponding data element being selectable.

49: The system according to claim 44, wherein the system comprises a retinal scanning display for display of picture data and/or an eye tracking system for capturing the direction of view of the user.

50: The system according to claim 44, wherein the system comprises a MEMSRSD for display of picture data and for capturing the direction of view of the user.

51: The system according to claim 44, wherein the system comprises means for bringing the acceleration sensor into an energy-saving idle mode according to definable deactivation criteria as well as of activating the acceleration sensor out of the energy-saving idle mode, through selection of the direction of view of the user, onto a definable activation picture element of the picture data shown to the user.

52: The system according to claim 43, wherein the system for electrical energy supply comprises an energy store and/or a solar generator and/or an automatic acceleration generator and/or a fuel cell system.

53: The system according to claim 43, wherein a device identifier is storable together with the data element in the look-up table.

54: A device for body-controlled transmission to a terminal of data elements to be selected, the device comprising:
a look-up table for storing reference values as well as assigned data elements; wherein
the device is attachable to a part of the body of a user, acceleration values and/or vibration values able to be influenced by bodily movements of the user being able to be captured by an acceleration sensor of the device,
the device comprises a comparison module for comparing acceleration values and/or vibration values with reference values, a data element assigned to a reference value being selectable by the comparison module, and
the device comprises a transmission module for transmission to a terminal of the selected data element.

55: The device according to claim 54, wherein
picture references are storable in the look-up table, at least one reference value and corresponding data element being assignable to a picture reference,
a picture data cutout corresponding to the direction of view of the user being transmittable to the device, and
the comparison module comprises means for comparing a picture data cutout with picture references and for selection of a data element based on this comparison.

56: The device according to claim 54, wherein sequences of reference values as well as assigned data elements are storable in the look-up table, the device comprises a sequence module for capturing and processing sequences of acceleration values and/or vibration values, and the comparison module comprises means for comparing sequences of acceleration values and/or vibration values with sequences of reference values as well as for selecting a data element assigned to a sequence of reference values.

57: The device according to claim 54, wherein the device comprises a signalling device for signalling to the user the transmission of a data element to the terminal.

58: The device according to claim 54, wherein the device comprises a feedback device for signalling to the user accomplishment of points of a bodily movement.

59: The device according to claim 54, wherein position references and assigned data elements are storable in the look-up table, body-position data of the user being able to be captured by a position module, and position references and body-position data being comparable, and a corresponding data element selectable, by the comparison module.

60: The device according to claim 54, wherein the device comprises means for bringing the acceleration sensor into an energy-saving idle mode in accordance with definable deactivation criteria as well as means for activating the acceleration sensor out of the energy-saving idle mode in accordance with definable control criteria.

61: The device according to claim 54, wherein the device for electrical energy supply comprises an energy store and/or a solar generator and/or an automatic acceleration generator and/or a fuel cell system.

62: The device according to claim 54, wherein a device identifier is storable with the data element in the look-up table.
